(19) United States
(12) Patent Application Publication
(10) Pub. No.: US 2025/0053803 A1
(43) Pub. Date: Feb. 13, 2025

(54) DEEP LEARNING OPTIMIZATION THROUGH ZERO TILE MANIPULATION

(71) Applicant: International Business Machines Corporation, Armonk, NY (US)

(72) Inventors: Monodeep Kar, New York, NY (US); Subhankar Pal, White Plains, NY (US); Alper Buyuktosunoglu, White Plains, NY (US); Sanchari Sen, White Plains, NY (US)

(21) Appl. No.: 18/448,390

(22) Filed: Aug. 11, 2023

(51) Int. Cl. G06N 3/08

(52) U.S. Cl. CPC G06N 3/08; G06N 20/00

(57) ABSTRACT

Processing zero weights within a data structure when performing a multiply and accumulate operation in a deep learning network as the result is itself a zero. Avoiding this step may save time and reduce power consumption in the training and operation of deep learning networks. An approach to zero-tile manipulation may be presented herein. An approach to permute and pack weighted data structures into zero-tile data structures may be presented. The zero-tiles may be configured in a structure which is optimized for the architecture of a parallel processing unit. The zero tile data structures may comprise vectors which instruct a the components in processing element to operate in a manner which prevents the element from expending energy when processing the zero tiles. An apparatus may also be presented in the immediate disclosure which can be configured to accept a zero-tile data structure.

### BACKGROUND

The present invention relates to data processing, and more specifically, to operating deep learning models that include matrices of zero-weight values.

A tile processor is computer hardware that typically includes multicore or manycore chips that contain two-dimensional arrays of identical tiles. Each tile includes a compute unit (that is, a processing engine or CPU), caches and a switch. Tiles can be viewed as adding a switch to each core. A core includes this compute unit and associated caches. In a typical tile processor, the switches in each of the tiles are connected to each other using mesh networks. For example, some commercially available tile processors include a CPU, L1 and L2 caches and switches for several mesh networks.

### SUMMARY

Embodiments of an apparatus for processing zero-tiles in deep learning models, may be disclosed. The apparatus may comprise a parallel processing unit, wherein the parallel processing unit comprises a plurality of processing threads comprised of a plurality of processing elements, wherein the plurality of processing elements include at least two single instruction multiple data lanes, the plurality of single instruction multiple data lanes each comprising a multiply and accumulate unit configured to process at least a zero-tile format data structure.

Embodiments of the apparatus may further comprise clock gate logic components configured to receive a zero tile, wherein the logic function causes the clock logic component to prevent a multiply and accumulate unit from operating, only passing a sum from a previous operation through as output across the plurality of single instruction multiple data lanes.

Additionally, embodiments of the apparatus may further comprise data gate logic components configured to receive a zero tile, wherein the logic function prevents toggling the inputs to the multiply-accumulate circuit and forward a sum and an activation from a previous operation as output across at least one of the plurality single instruction multiple data lanes, corresponding to the single instruction multiple data lanes that read the zero-tile vector instruction.

Additionally, embodiments of the apparatus may further comprise read gate logic components configured to receive a zero tile, wherein the logic function causes the read logic component to prevent a read operation from a register file lane corresponding to a single instruction multiple data lane of the plurality of single instruction multiple data lanes.

Further, embodiments of the apparatus may be configured to switch off a processing thread in response to a tile data structure comprised entire of zero tiles.

The present disclosure may also disclose an embodiment of a computer-implemented method for generating tile data structure comprised of zero-tiles from a weight-based data structure. The computer-implemented method may comprise, pruning, by the processor, a weight-based data structure, wherein the weight-based data structure is formatted into a plurality of rows and columns, permuting, by the processor, the pruned weight-based data structure into a tile format, determining, by the processor, if the permuted weight-based data structure contains any zero-tiles, and generating empty tile index vectors which are used to configure the gating logic in the processing tiles for corresponding gating operations.

Additionally, embodiments of the computer-implemented method may further comprise determining, by the processor, the clustering efficiency of the permuting, based on a clustering algorithm and a cost function.

Additionally, embodiments of the computer-implemented method may further comprise providing, by the processor, the pruned weight-based data structure of an Artificial Intelligence model, wherein the model is trained to condense the weight-based data structure into a tile format, wherein the tile format is based on the parameters of a parallel processing unit.

Additionally, the computer-implemented method may also include embodiments where the parameters of the tile format is based on the number of single instruction multiple data lanes contained in a processing element of the parallel processing unit.

Additionally, the computer-implemented method may also include embodiments where the gating operations comprise at least one of the following clock gating, data gating, and read gating.

Furthermore, the computer-implemented method may also include embodiments where permuting further comprises transposing, by the processor, the plurality of rows into columns of the pruned weight-based data structure for each iteration.

Additionally, the computer-implemented method may also include embodiments where the the processing tile bypasses input-data across the multiply-accumulate pipeline for at least one cycle (pipeline-skip operation), wherein the cycle corresponds to a row or a column of the data-structure containing all zero-tiles.

Additionally, the computer-implemented method may also include embodiments where the pipeline skip operation causes a processing element to skip the pipeline in a multiply and accumulate unit and forward the input data to the outputs.

Additionally, the computer-implemented method may also include embodiments where the read gate operation causes a processing element to prevent reading of a zero-tile.

Additionally, the computer-implemented method may also include embodiments where permuting can be configured to be completed at a host in an end-to-end format.

Additionally, the computer-implemented method may also include embodiments where permuting can be configured to be completed on a single layer of the weight-based data structure corresponding to a deep learning network.

The present disclosure may also disclose an embodiment of a computing system for manipulating zero-tile data structures, the computer structure may comprise a processor, which may be a parallel processing unit, a memory, and program instructions stored on the memory causing the processor to perform one or more operations. The operations may comprise a permute operation of a weight-based data structure based on zero weights within the data structure, wherein the weight-based data structure is a matrix comprised of weights associated with a deep learning network. An operation to generate a data processing program for the permuted data structure, based at least in part on the plurality of tiles and a parallel processing unit. An operation to generate a plurality of empty tile index vectors, based at least in part on the data processing program. An operation to execute the processing program on the parallel processing unit, wherein the parallel processing unit receives at least one of the empty tile index vectors causes the parallel processing unity to switch off a component in a multiply and accumulate unit.

Further, the computer system may also include an embodiment where the parallel processing unit is comprised of a plurality of processing threads with single instruction multiple data lanes and wherein the plurality of tiles is a data structure with columns corresponding to the number of single instruction multiple data lanes.

### BRIEF DESCRIPTION OF THE DRAWINGS

FIG. 1 depicts and example of a computing environment which may perform the disclosed operations, in accordance with an embodiment of the invention.

FIG. 2 depicts an example of a computing component pipeline capable of performing the disclosed operations, in accordance with an embodiment of the present invention.

FIG. 3 depicts a high-level example of generating a zero-tile data structure from a weighted data structure, in accordance with an embodiment of the present invention.

FIG. 4a depicts an example of a parallel processing unit capable of processing a zero-tile data structure, in accordance with an embodiment of the present invention.

FIG. 4b depicts and example of a processing element found in FIG. 4a capable of executing program generated for the processing zero-tile data structure.

FIG. 5. depicts a process for generating a program for executing a zero-tile data structure and generating a zero-tile data structure.

### DETAILED DESCRIPTION

Embodiments of the present invention may be a deep learning accelerator with a compiler-hardware co-designed set of features configured to exploit random zeros in the weights of a neural network. Advantages of exploiting random zeros in the weight of a neural network may provide an overall reduction in power consumption and improvement in the performance of neural network processing. Even further, embodiments of the invention may include an iterative permute-and-pack algorithm, which may create variable sized zero-tiles and/or generate customized programs with an awareness of some parameters of the hardware. Further yet, embodiments of the invention may perform these operations independently of any model pruning/re-training step. Additional advantages of embodiments of the disclosed hardware-complier co-design may allow for efficient index storage of zero-tiles, programmable tile-size, and additional clock and data-gating support.

Deep learning accelerators use an array of processing elements to perform multiply-accumulate operations. In the accelerators various dataflows exist which map different data structures on to the array. Weight-stationary dataflows store the weights in local register files inside of a processing element. The activations and outputs associated with the dataflow pass through the processing element, where control signals are shared across a row within the array. Within this array if the activation, weight, or resulting sum is zero, the switching activity of the processing element is reduced providing a reduction in overall power consumption of the chip. This can also result in skipping processing cycles improving the overall performance of the system. The elimination of redundant fetches of zero-elements from the register file may also further aid in power reduction.

Current state-of-the-art deep learning accelerators utilize an array of processing elements to perform multiply-accumulate operations in a systolic fashion. In these deep learning accelerators, various dataflows exist to map different data structures on to the processing element arrays. For example, in a weight-stationary dataflow, the weights are stored in local register files inside the processing elements of the arrays. Activations and outputs flow through the processing elements and control signals are shared across a row. If the activations, weights, or sum within the row are zeros, a power switching operation can be performed (i.e., the row of processing elements is turned off) and the power of the deep learning accelerator is reduced.

Additional power reductions can be accomplished through appropriate data and clock gating for zero operands. For example, detection of zeros in the activation prior to sending the activation to the processing element can save power by skipping computation across an entire row of the systolic array. An approach for detecting and exploiting random zeros in the weights for additional power reduction in deep learning accelerators would be advantageous.

These techniques have been proposed in prior art mostly within the context of coarse-grained structured pruning/sparsity. One example of this is N: M structured sparsity where N out of every M-element group in a row/column are zeroed out. Another example of structured sparsity is neuron or filter pruning, where an entire neuron in a fully-connected layer, or a filter in a convolutional layer, is eliminated. Such methods eliminate network parameters in groups rather than at a single-parameter level, and hence are termed coarse-grained. In contrast, fine-grained unstructured pruning/sparsity is the removal of individual parameters of the network based on importance with no regard to the structure of the deep learning model or the hardware. For instance, a scheme may choose to sort all the weights of the network based on their absolute values and remove a certain percentage of the smallest weights. Unstructured sparsity leads to higher ratios of zeros to non-zero elements (compression ratio) without leading to a degradation in the accuracy of the neural network, as they impose fewer constraints on the pruning process, but this provides less performance and power benefits compared to structured sparsity on modern hardware, mostly due to the overhead of storing indices of the zeros in the weight matrices. Embodiments of the present invention may propose a method of converting the fine-grained unstructured sparsity into coarse-grained unstructured sparsity (while retaining the same compression ratio) and a co-designed set of hardware features which may exploit this sparsity resulting in a reduction of power consumption and an increase in performance.

A preferred embodiment of the present invention may include a gating logic, in which no weights will be read from the register file structure within a tile. Additionally, the multiply and accumulate unit within the processing element is also gated. The processing element may be configured with single instruction multiple data (“SIMD”) lanes. For example, the tile size may be N×DSIMD×Dcol. (i.e., DSIMD=8, Dcol=8) (e.g., 4k×64). In this example, the performance savings is obtained via skipping K−1 cycles in all the Dcol processing elements in the row and by directly forwarding the data to the next row, where K is the pipeline depth of the multiply-accumulate operation within a processing element. Similarly the tile size may be N×DSIMD×Drow where performance savings can be obtained by skipping J−1 clock cycles by directly forwarding the data to the next column, J being the number of clock cycles input data is staged within a processing element.

In another embodiment, power savings can be achieved via data and/or clock gating within a single processing element. For example, the tile size may be N×DSIMD (e.g., 4k×8). In this example, the power savings is achieved by skipping reading of the weights as well as disabling the pipeline of the multiply and accumulate units. However, input data is still forwarded to the next processing element.

Embodiments of the present invention may leverage a systolic element weight storage structure. In the systolic element weight storage structure, each entry of the register file may contain a weight for all or partial of the SIMD lanes. The SIMD lanes may be mapped to the processing element. In an embodiment, the weight element for one SIMD lane may contain multiple weight operands, depending on the precision of the arithmetic. An example of the systolic element weight storage structure may be a structure where entry of the register file holds 16 weight values; in which there are 2 weights per SIMD (e.g., input channel) and eight SIMDs (e.g., output channels); and two registers files which read in parallel.

In an embodiment, the power reduction may be achieved through data and clock gating where the tile size is N×M, where M<DSIMD. In this example, assuming width of the each register file is W elements, the power savings are achieved by skipping reading of weights from [M/W] register-files. However, the multiply accumulate unit is not clock-gated and data is forwarded to the next processing element. The embodiments described in this paragraph will be further described with respect to the figures below.

In an embodiment, a system logic may be utilized to accomplish power savings or performance enhancement. For example, the system logic in response to a zero-weight tile may have an function of “no write” to the weight register file during weight loading. Another portion of the enabling logic may include an function of a “no read” operation from the register file during a computation operation (e.g., read is multiplexed, read data multiplexed to 0). Further another function may perform a clock gate and a data gate for the operand latches and the intermediate multiplier pipeline registers from the enabling logic.

In an embodiment, the weight matrix may be divided into a variable tile-size with the zero-tile location stored in the index bits. For example, there may be no change to the weight register file (e.g., the block size may be “N×DSIMD”, where DSIMD is the number of SIMD lanes). It should be noted that index register files are typically used to support fine-grained structured sparsity in deep learning accelerators. These index registers can be repurposed to store zero-tile indices in some embodiments of the present invention. In yet another example, the register files may be split into multiple slices with individual read/write enabling signals for tiles with widths less than DSIMD.

In an embodiment, the tile indices may be passed as pre-computed data streams as part of the weight loading phase of the computation process. In another embodiment, the tiles may be computed dynamically while they are being copied to the register file of the processing element. In this embodiment, an additional integrated circuit may compute and detect the zeros in the data structure. In both embodiments of this fashion, the program data executed in the processing tiles only contain the tile-size and an additional bit to enable or disable the gating logic functionality.

In another embodiment, the program data being executed in the processing tiles contain both the empty tile indices, tile size and the additional bit to enable or disable this logic.

In an embodiment, the non-zero weight values along each processing element column with a tile width equal to the DSIMD can be packed, which reduces the memory-footprint of the weights. This leads to performance improvement due to reduction in number of cycles to read the weights. A separate finite state machine within each processing element either stores the incoming weigths in its local register file or forwards it to the next processing element, based on the zero-tile indices, all during the weight loading operation. This requires decoupling of the shared control signals across a row, typical in any systolic array architecture. In yet another embodiment, the control may be shared across a sub-group of processor threads in a row (e.g., 2 groups of 4 processor elements in an 8×8 array configuration).

Embodiments of the present invention may include a permute algorithm associated with a compiler and that is aware of the hardware parameters, e.g., size of the registers and processing element arrays. The permute algorithm may efficiently take a weight matrix as an input and re-arrange its rows and columns to increase the number of zero tiles (i.e., sub-matrices within the matrix that contains all zero elements) through a clustering algorithm (e.g., k-means). The algorithm may be run iteratively for a predetermined number of times or until the weight matrix has reached an optimal number of zero tiles (e.g. the number of zero tiles are no longer being reduced since the past few iterations). A variation of the algorithm may include exhaustive search of valid permutations to find one that has the most number of zero tiles. Permuting each weight matrix in isolation would add the need to add a new permute layer before and after the permute weight matrix, in order to ensure that the inputs to the network are paired with the correct weights as in the original network. This may add additional overhead, to counteract the additional overhead, an embodiment may group together multiple layers and permute them in groups. For example, if a neural network has connections A->B->C+D->E, the permute algorithm may create two permutation groups and transform the neural network into P->A->B->P′->C+D->E->P″, where P, P′, P″ are the new permute layers and the rest are the original layers of the network. Within each group, the algorithm permutes layers that are connected together in tandem.

An embodiment may include a permutation of the entire neural network as a single group. In permuting the entire neural network as a single group, the embodiment may generate only two permute layers, P and P′.

In another embodiment, may include permuting a sub-network within the network. Once again referring to the neural network with connections A->B->C+D->E, the network may be transformed into P->A->B->P′->C+D->E. In this example only the sub-network A->B is permuted.

In an embodiment, the permute layers are performed on a host CPU and the remainder are performed on the artificial intelligence hardware.

In another embodiment, the artificial intelligence hardware is responsible for performing the permute layers, e.g., by treating them as matrix multiplication (GEMM) operations.

In an embodiment, the resulting output of the permute and pack algorithm may be a network with zero tiles of various shapes, where the network shapes are defined by the parameters of the computational hardware, including but not limited to, the dimension of the systolic array, the SIMD dimension within each processing element, and the bitwidth of the register file. Further, each pair of matrices may use an independent tile shape, among the list of hardware-compatible tile shapes, for clustering operations.

In an embodiment, the compilation flow may be as follows: 1) permutation and packing on the weight matrices; 2) generating programs with tile sizes corresponding to the deep learning hardware; 3) generating empty tile index vectors corresponding to the locations of zero tiles in the network layers; 4) loading the parameters of the network and zero tile index vectors on the deep learning hardware; and 5) executing the generated programs on the deep learning hardware.

An embodiment of the present invention may execute one or more of the permute layers on the central processing unit (CPU) present in the system-on-chip. The input/output to the permute layer may flow through an on-chip communication network between an artificial intelligence hardware and the CPU.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

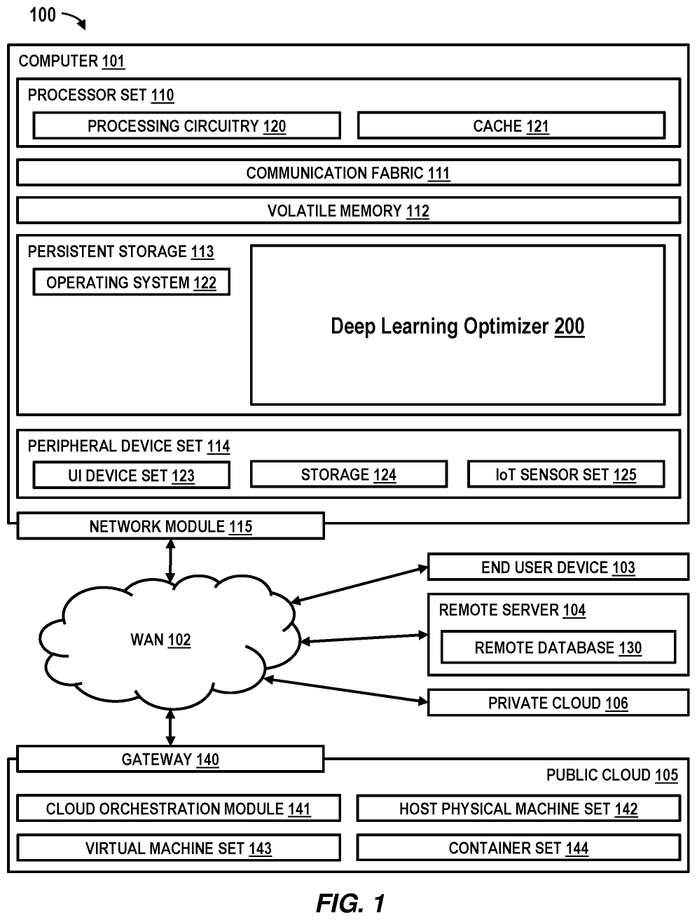

Now referring to FIG. 1. Computing environment 100 contains an example of an environment for the execution of at least some of the computer code involved in performing the inventive methods, such as deep learning optimizer 200. In addition to deep learning optimizer 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and deep learning optimizer 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in deep learning optimizer 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in deep learning optimizer 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

UD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

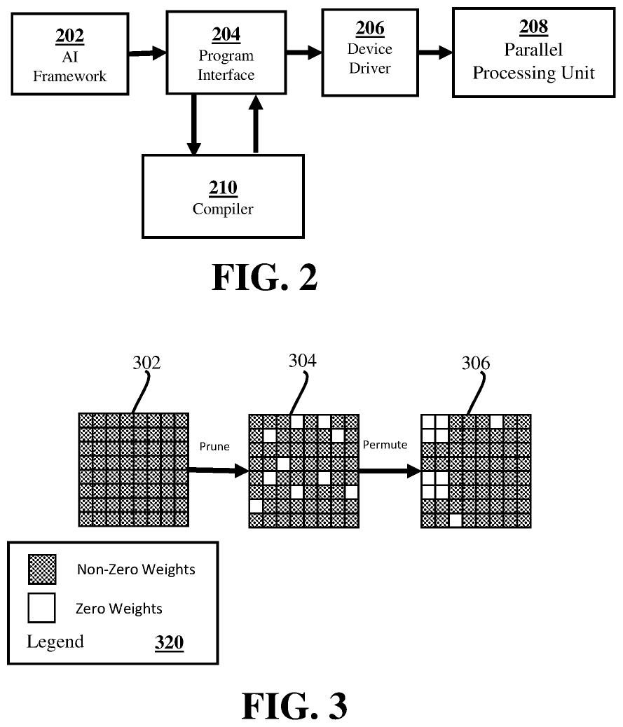

Now with reference to FIG. 2. FIG. 2 is a block diagram depicting a system capable of deep learning optimization through manipulation of zero tiles in accordance with an embodiment of the invention. It should be noted deep learning optimizer 200 may operate in an abstraction above one or more of the components of FIG. 2, for example, deep learning optimizer 200 may control or operate within programming interface 204 and/or compiler 210. FIG. 2 further depicts the flow of a weighted data structure which is read from left to right. AI framework 202 is a deep learning model (e.g., a neural network) which can have a weighted data structure associated with it. Program interface 204 can be a user interface module operational on a computer allowing a user to inspect the AI framework. Program interface is coupled to compiler 210. In an embodiment, compiler 210 may be the component which permutes a weighted data structure as a tile format configured to operate within the confines of parallel processing unit 208. Complier 210 can further generate the index vectors corresponding to zero-tiles within the tile data structure. These vectors are associated with the logic orchestration (described further below). Compiler 210 can further be configured to generate a program which can be administered by device driver 206. In an embodiment, device driver 206 is a module which translates the data structure into a language readable by parallel processing unit 208. This translation includes accepting the index vectors associated with tiles and performing operations within the logic structure of the parallel processing unit 208.

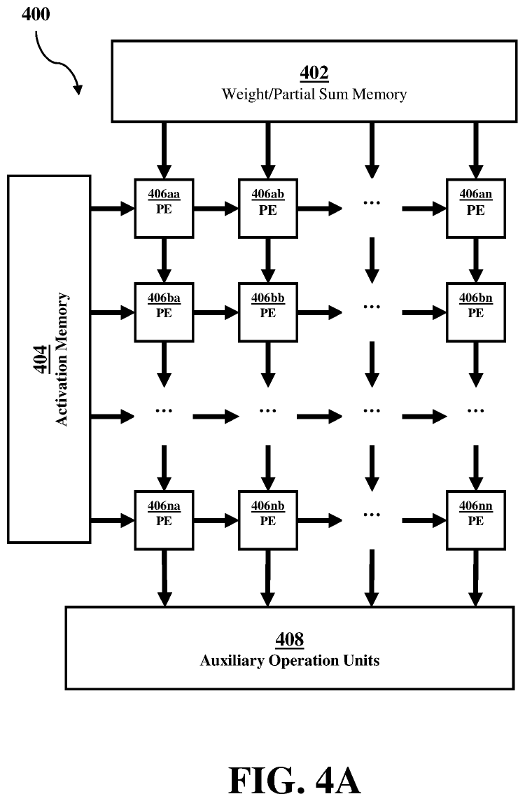

Now with reference to FIG. 3. FIG. 3 is diagram 300 visually depicting the steps involved in configuring a weighted data structure into a tile data structure which includes zero weight tiles in accordance with an embodiment of the invention. FIG. 3 is intended to be a non-limiting example of the location of zero tiles within the data structure and not the operation of condensing an data structure into a format configured to operate within the parameters of a processing unit. Legend 320 of diagram 300 shows the shaded blocks as tiles which contain non-zero weights, while the unshaded blocks are tiles with zero weights. Block 302 shows a weighted data structure in tile format prior to pruning. Block 304 shows the tile structure after the pruning process. Pruning is a process which removes weights within the weighted data structure. This reduces the overall size of the weighted data. Generally, the impact upon the accuracy of the weighted data structure is minimal as a majority of weights do not significantly contribute to the activation process. The result in the pruning process can be a fine-grain weight structure allowing for less processing due to fewer weights in the data structure. Further, as show in block 304 zero tiles exist within the data structure due to the pruning. It should be noted, zero tiles may exist prior to the pruning stage and many times zero weights exist within a weighted data structure. This is intended to be a non-limiting example for clarity purposes.

Block 306 shows the tile data structure after the permute step of a pruned data structure. It should be noted, throughout this disclosure permute and pack may be used to describe similar functions and are used interchanagabley thougout and should be accorded the same meaning. In accordance with and embodiment of the invention, a convolution may be performed on the pruned data structure (i.e., by a convolutional neural network), this convolution further condenses the data structure and can result in a data structure with number of columns that correspond to the number of single instruction multiple data lanes in a processing element of a parallel processing unit. In block 306 the permutation depicts additional zero tiles clustered together. In an embodiment, this can occur because the tile data structure can have the rows of the data structure permuted, then the data structure can be transposed switching the rows and columns. A permutation can then be run on the transposed columns (which are now rows). This process further condenses the data structure and results in a general clustering of the zero tiles due to the dimension reduction of tiles in the space.

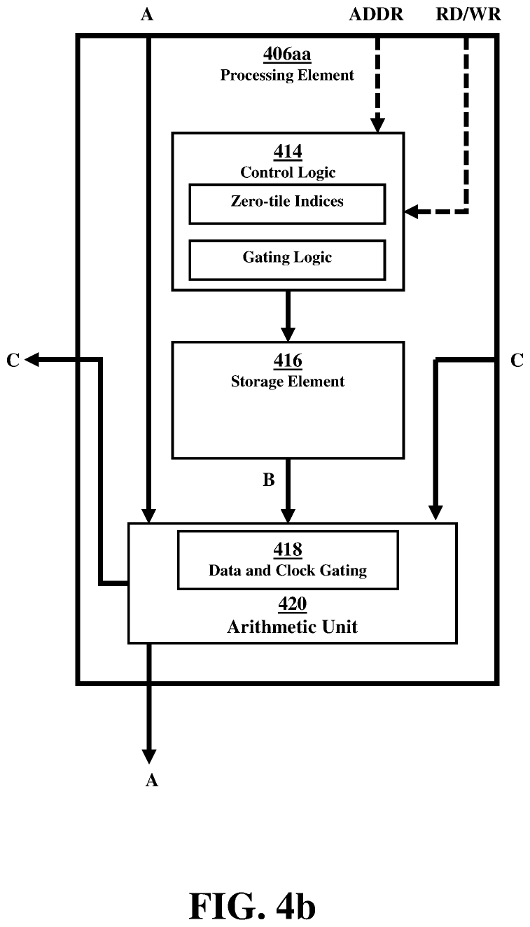

Now with reference to FIG. 4a, depicts parallel processing unit 400 in accordance with an embodiment of the invention. Show in parallel processing unit 400 is weight/partial sum memory 402, activation memory 404, auxiliary operations unit 408, and Processing element 406aa through processing element 406nn. Parallel processing unit 400 is a device which can perform processing operations in parallel. Examples of parallel processing units include but are not limited to graphics processing units (GPUs), tensor processing units (TPUs), and various application specific integrated circuits (ASICs). Parallel processing allows for multiple computations (i.e., a broader insertion of data into the unit) to occur simultaneously, effectively removing a bottleneck in the processing which is inherent in single processing by CPUs.

Weight/partial sum memory 402 can be a memory where configured weight data structures of deep learning models can be loaded structure. In an embodiment, the weight data structure may comprise index pointers or vectors which point to the location of the data in the weight partial sum memory 402. Weight/partial sum memory 402 can also comprise partial sums of computations which were not completed in a prior clock cycle or the like. Activation memory 404 can be a memory where input activations are loaded. Activations are the amounts required to activate a node within a deep learning model. The activations can be compared to the weight multiplied by the data structure. Auxiliary operations units 408 can be a memory for storing the output of the processed weights and inputs/activations.

Processing element 406aa is a processing element comprised of components for processing data (described in FIG. 4b). Processing elements can be arranged in an array composed rows (e.g., 1, 2, . . . n, n+1) and columns (e.g., 1, 2, . . . n, n+1). As shown in FIG. 4a data flows from top to bottom (i.e., PE 406aa to PE 406na) and from left to right (i.e., PE 406aa to PE406an) with the data flowing in a corresponding column and or row).

Now with reference to FIG. 4b, depicts an exemplary processing unit (e.g., PE 406aa) and associated data flow in accordance with an embodiment of the invention. Shown operational of PE 406aa is adder 410, tile control logic 412, gating logic 414, storage element 416, data and clock gating 418, and arithmetic unit 420.

As stated above, a program for a tile data structure comprised of non-zero weights and zero weights can be generated. The tile data structure is configured where the number of columns in the tile structure corresponds to the SIMD lanes in a processing element. The tile structure can be any number of rows (e.g., 1, 2, n, . . . n+1). The zero tiles can be clustered together in rows or columns. In a preferred embodiment, the zero tiles are configured to occupy an entire row or an entire column of the parallel processing unit. In this instance, a pipeline skip logic within the processing elements prevents the arithmetic unit from performing any operation with an n-way pipelined multiply-accumulate, with the exception of a partial sum from a prior operation being output by the processing elements. This action causes a reduction in the total number computations required, thus improving performance of the parallel processing unit.

In another embodiment of the present invention, a tile data structure can have zero tiles clustered together, where only a portion of a row in the tile structure is occupied by zero tiles. In this embodiment, an index vector and a data-gating logic operation can be used by the processing element. This may cause the data-gating logic to prevent a read operation of the weight a register file corresponding to weights (e.g., storage element 416). In an embodiment, if multiple zero tiles are stacked up in the column behind the initial column, the control logic may prevent a write operation to the processing element register file for a number of cycles corresponding to the number of stacked zero tiles.

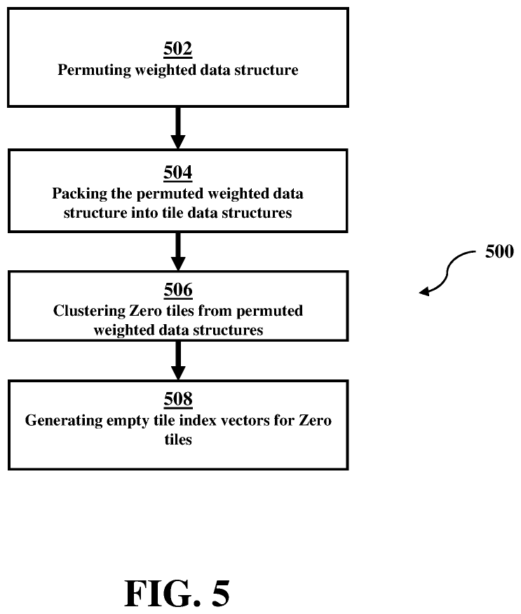

FIG. 5 shows process 500 for accelerating deep learning through zero-weight tile manipulation. Step 502 deep learning accelerator may with permute a weighted data structure associated with a deep learning model. In an embodiment, the weighted data structure may be in a matrix format of M rows and N columns. The weighted data structure may be pruned to a predetermined or dynamic percent of sparsity in a previous process and provide a fine-grained weighted data structure for permutation. In an embodiment, permuting the weighted data structure may consist of permuting (e.g., through a convolutional filter) the rows of the data structure followed by permuting the columns of the data structure for a number of iterations.

At step 504, deep learning optimizer 200 packs the permuted weighted data structure into a predetermined tile format which can be supported by the parallel processing unit for maximum processing efficiency.

At step 506, deep learning optimizer 200 clusters the zero tiles of the packed tile structure. In an embodiment, clustering consists of identifying the zero tiles in the packed tile data structure and clustering those tiles based on a clustering algorithm. Further clustering may include executing a cost function, such as a hamming distance, to determine the effectiveness of the clustering algorithm. For example, it may be more cost efficient to cluster the zero tiles into a single row, rather than cluster the tiles into a single column. In another example, zero tiles may be packed together to take up a 4 tile row×4 tile column block due to the structure of the deep learning model and reducing, read, write, and fetch operations.

What is claimed is:

1. An apparatus for processing zero-tiles in deep learning models, the apparatus comprising:
a parallel processing unit, wherein the parallel processing unit comprises a plurality of processing threads comprised of a plurality of processing elements, wherein the plurality of processing elements include at least two single instruction multiple data lanes, the plurality of single instruction multiple data lanes each comprising a multiply and accumulate unit configured to process at least a zero-tile format data structure.

2. The apparatus of claim 1, further comprising, clock gate logic components configured to receive a zero tile, wherein the logic function gates the clock to the multiply and accumulate unit, only passing a sum from a previous operation through as output across the plurality of single instruction multiple data lanes.

3. The apparatus of claim 1, further comprising, data gate logic components configured to receive a zero tile, wherein the logic function prevents toggling of the inputs to the multiply-accumulate circuit components, thus saving power and pass through a sum and an activation from a previous operation as output across at least one of the plurality single instruction multiple data lanes, of the plurality of single instruction multiple data lanes.

4. The apparatus of claim 1, further comprising, read gate logic components configured to receive a zero tile, wherein the logic function causes the read logic component to prevent a read operation from a register file corresponding to a single instruction multiple data lane of the plurality of single instruction multiple data lanes.

5. The apparatus of claim 1, further comprising, pipeline skip logic components configured to receive a zero tile, wherein the logic function allows the input data across all the processing tiles in a row or a column to bypass the multiply-accumulate pipeline, thus improving performance.

6. The apparatus of claim 2, wherein the apparatus is configured to switch off a processing thread in response to a tile data structure comprised entire of zero tiles.

7. A computer implemented method for generating tile data structure comprised of zero-tiles from a weight-based data structure, the computer-implemented method comprising:
pruning, by the processor, a weight-based data structure, wherein the weight-based data structure is formatted into a plurality of rows and columns;
permuting, by the processor, the pruned weight-based data structure into a tile format and augmenting the neural network with one or more permute layers;
determining, by the processor, if the permuted weight-based data structure contains any zero-tiles;
generating, by the processor, empty tile index vectors, wherein the empty tile index vectors are used to configure the gating logic in the processing tiles.

8. The computer-implemented method of claim 7, further comprising determining, by the processor, the clustering efficiency of the permuting, based on a clustering algorithm and a cost function.

9. The computer-implemented method of claim 7, wherein pruning comprises:
converting, by the processor, weight-based data structure from a fine-grained unstructured sparsity into a coarse-grained unstructured sparsity.

10. The computer-implemented method of claim 7, wherein permuting further comprises:
providing, by the processor, the pruned weight-based data structure to a convolutional neural network, wherein the convolutional neural network is trained to condense the weight-based data structure into a tile format, wherein the tile format is based on the parameters of a parallel processing unit.

11. The computer-implemented method of claim 10, wherein the parameters of the tile format is based on the number of single instruction multiple data instruction lanes contained in a processing element of the parallel processing unit.

12. The computer-implemented method of claim 7, wherein the operations comprise at least one of the following gating operations: data gating, clock gating, and read gating.

13. The computer-implemented method of claim 9, wherein permuting further comprises:
transposing, by the processor, the plurality of rows into columns of the pruned weight-based data structure for each iteration.

14. The computer implemented method of claim 11, wherein the pipeline skip operation causes a processing element to skip at least one cycle in a multiply and accumulate unit, wherein the cycle corresponds to a row or a column of the data-structure containing all zero-tiles.

15. The computer implemented method of claim 11, wherein the data gate operation causes a processing element to prevent toggling the inputs to the multiply accumulate unit.

16. The computer-implemented method of claim 7, wherein the network is permuted end-to-end to and there is an addition of one permute layer at the network input and another permute layer at the network output.

17. The computer-implemented method of claim 7, wherein the permute layers can be executed on the host, or the artificial intelligence accelerator hardware, or be distributed between them.

18. A computing system for manipulating zero-tile data structures, the computer structure comprising:
one or more computer processors;
one or more computer readable storage devices; and
computer program instructions, the computer program instructions being stored on the one or more computer readable storage devices for execution by the one or more computer processors to perform one or more operations comprising:
generate a weight-based data structure based on zero weights within the data structure, wherein the weight-based data structure is a matrix comprised of weights associated with a deep learning network;
generate a plurality of empty tile index vectors, based at least in part on the data processing program; and
generate a data processing program for the permuted data structure, based at least in part on the plurality of tiles and a parallel processing unit;
execute the processing program on the parallel processing unit, wherein the parallel processing unit receives at least one of the empty tile index vectors that causes the parallel processing unit to switch off a component in a multiply and accumulate unit.

19. The computer system of claim 18, wherein the parallel processing unit is comprised of a plurality of processing threads with single instruction multiple data lanes and wherein the plurality of tiles is a data structure with columns corresponding to the number of single instruction multiple data lanes.

20. The computer system of claim 18, wherein the component in the multiply and accumulate unit is a logic gate.
